(19) United States
(12) Patent Application Publication
(10) Pub. No.: US 2018/0268238 A1
(43) Pub. Date: Sep. 20, 2018

(54) SYSTEM AND METHODS FOR ENHANCING LICENSE PLATE AND VEHICLE RECOGNITION

(71) Applicant: Mohammad Ayub Khan, Santa Clara, CA (US)

(72) Inventors: Mohammad Ayub Khan, Santa Clara, CA (US); Syed Muhammad Ziauddin, Islamabad (PK); Imran Ul Haq, Islamabad (PK); Syed Ali Hassan, Islamabad (PK); Moeen Tayyab, Islamabad (PK); Haroon Ur Rashid, Islamabad (PK)

(73) Assignee: Mohammad Ayub Khan, Santa Clara, CA (US)

(21) Appl. No.: 15/458,259

(22) Filed: Mar. 14, 2017

(51) Int. Cl. G06K 9/32; G08G 1/017; G06K 9/18; G06K 9/62; G06F 17/30

(52) U.S. Cl. CPC G06K 9/325; G08G 1/0175; G06K 9/18; G06F 17/30253; G06F 17/3028; G06F 17/30259; G06K 9/6202

(57) ABSTRACT

A system and methods are disclosed for enhancing license plate recognition (LPR) and vehicle feature recognition processes in automatic vehicle access control, parking management, automatic toll collection and security applications. The system uses optical character recognition (OCR) to read license plates, while utilizing image feature recognition to verify plate reading results, and correct any OCR read errors, thereby increasing system accuracy. The system automatically controls the actuation of one or a plurality of gates/barriers to allow entry and exit of authorized vehicles to or from a premises, a parking lot or a toll station. In the event of failure of the OCR algorithm to identify a license plate of an authorized vehicle at an entry or exit point, the system allows a human operator or the driver/passenger of the said authorized vehicle to override its decision, and allow the vehicle to pass by opening the gate or barrier through external means including card reader, bio-metric scanner, key fob, cell-phone/smart phone, wireless transceiver, electro-mechanical switch/button, or PC/Web based application. This overriding action of opening the gate/barrier through the said external means is used to tune the license plate and vehicle recognition system, causing it to adapt its algorithms to perform better when it encounters the same vehicle again. Besides the above aspect, the present invention discloses fast and memory-efficient methods for image feature matching that are well suited for real-time situations where the set of reference image features is changing with time as new vehicles arrive. In addition to the above aspects, the present invention discloses an LPR database update method that simplifies license plate misread corrections process in the database, thereby improving the accuracy of subsequent database search queries. Furthermore, the present invention discloses methods in an LPR system that account for all the passing traffic by categorizing and recording license plate/vehicle captures as read-plate records, unread-plate records, or vehicles with missing license plates. In addition to the above aspects, the present invention discloses methods for switching between normal and privacy modes of operation and between different security levels.

### FIELD OF THE INVENTION

The present invention relates to the use of license plate recognition and image feature matching processes in automatic vehicle access control, parking management, automatic toll collection and security applications. More specifically, the invention relates to enhancements in license plate recognition and image feature matching processes for real-time applications.

### BACKGROUND OF THE INVENTION

The growing demand for personal and public safety, security of property, and efficient toll and parking payment collection mechanisms has prompted the development of intelligent traffic surveillance and monitoring systems. The first and foremost requirement for the success of automatic traffic monitoring and control systems is to achieve a high degree of accuracy in identifying vehicles from their license plates and other signatures. Autonomous traffic control systems require minimum human intervention and utilize automatic means for actuating gates and barriers to allow or deny vehicles to pass, and must meet stringent accuracy criteria. Efficient vehicle access control systems ensure fast and easy entry and exit in secure facilities, parking lots and toll stations for authorized vehicles, while preventing traffic congestion and unauthorized intrusions. Considering the traffic and security needs of an organization, managers can either go for manned or unmanned vehicle access control systems. Unmanned vehicle access control systems either come as hands-free type that automatically open gates and barriers for authorized vehicles, or require card readers, bio-metric scanners, key fob or cell-phones to operate the gates and barriers. Hands-free automatic vehicle access control (AVAC) systems are most attractive because of their hassle free operation.

AVAC systems can broadly be divided into two categories: Radio Frequency Identification (RFID) based systems and LPR based systems. RFID based systems are generally considered to be most secure by virtue of the error detection and correction information embedded in the RFID tags. However, use of RFID tags have their limitations. Drivers have to volunteer to get registered with the tag issuing authority and have to pay for the service. Vehicle owners have to attach RFID tags to the windscreens of their vehicles and take care that these are not disturbed or obstructed. Placing RFID tag may be particularly difficult if the windscreen has a metallic sun-protecting coating. These systems sometimes operate only at short ranges and are generally unable to pinpoint the exact location of a tag. Moreover, these systems may get confused if several tags are sensed in the vicinity. On the other hand, LPR based systems utilize video cameras to capture images of vehicles and use OCR algorithms to read license plate numbers to identify these vehicles. These systems can be deployed universally as all countries require vehicles to be equipped with at least one license plate. LPR systems can read license plates at longer ranges and do not place any maintenance burden on the end-user. Besides, LPR systems utilize day/night cameras and generate compelling evidence of traffic and other violations that is presentable in a court of law. Moreover, these systems can easily be used to target and flag vehicles wanted by law enforcement agencies.

Despite their advantages, OCR inaccuracies constitute a major hurdle in the success of LPR based systems, resulting in reading errors, and thus limiting their utility. Reading license plates becomes challenging due to a number of factors including poor quality or damaged license plates, improper lighting, multitude of fonts and plate types, fancy plate holders and weather or aging effects. Moreover, in LPR based recognition systems security may be compromised by fake license plates. It is for these reasons that LPR based vehicle recognition is mostly limited to applications where 80% to 90% reading accuracy is considered acceptable. AVAC systems on the other hand, demand much higher recognition rates. Therefore, to successfully deploy LPR based AVAC systems there is a need to improve their plate/vehicle recognition accuracy.

Realizing the above major deficiency in OCR based LPR systems, a number of innovations have been proposed in different inventions to improve the vehicle recognition accuracy. U.S. Pat. No. 7,466,223B2 and WO2008076463A1 disclose methods for automatic vehicle access control where in the event of LPR failure security personnel or parking supervisor are called for manual intervention, who may then correct the misread and allow the vehicle to enter. However, no effort is made on the part of the system to prevent the misread from occurring again. U.S. Pat. No. 8,781,172B2 describes methods to enhance general LPR systems by performing OCR on multiple captured images, combining the results, and obtaining the best plate number on the basis of maximum confidence level thresholds. These methods, however, cannot be applied to damaged or tampered license plates that have been rendered machine unreadable. Patent application No. US20130132166A1 discloses a toll network that improves vehicle identification to find matching pairs of vehicles at toll exit points. In this disclosure, first LPR based identification is performed, next, signature based identification is performed for unpaired vehicles, next, supplemental processing is performed to compare partial matches, and finally, human inspection is performed by narrowing the choices presented to the inspector. The disclosed methods, however, are not applicable to AVAC systems as signature matching and pairing of vehicles is performed only at exit points. Moreover, the system excludes all the vehicles that have exited the toll station from further processing. Thus, it does not improve its performance by taking advantage of the data of vehicles that routinely pass the toll station and form a major source of toll income. In addition, vehicle pairing by human inspection at exit points is a laborious and error prone process. U.S. Pat. No. 6,747,687B1 discloses methods for an entry-exit system that leave out the OCR altogether, and relies solely on image matching. Although generic, the disclosed methods can only be used for a limited number of cars as acknowledged by the inventors. The reason being that the most concise and unique feature of a vehicle, that is, the license plate number, has been ignored. Patent application No. US20110116686A1, Patent application No. US20110042462A1 and U.S. Pat. No. 9,025,828B2 describe methods to verify and correct OCR results where the license plate hosts additional graphic insignia such as a bar code or a sticker. These methods are not viable as they require replacing the existing license plates with new designs or mounting bar-codes on cars. Patent application No. US20050084134A1 tries to reduce OCR errors in an entry-exit system by receiving input from three sources (voice, keyboard, image) and synthesizing a plate number by giving highest priority to voice, then to the keyboard and finally to OCR. Such a system can only operate when the gates are continuously monitored. Also, no effort is made on the part of the system to prevent the OCR misreads from occurring again. U.S. Pat. No. 9,405,988B2 discloses an LPR system for roadway toll applications that improves plate reading accuracy by utilizing past verified data, and combining OCR and vehicle signature recognition technologies. The methods disclosed in this patent rely heavily on grouping images of the same vehicles along with extensive manual verification of images and text data. Problem with this method of grouping is that it depends on the number of times a vehicle is seen by the system and not on the difficulty level of plate reads. A vehicle with perfectly readable license plate that travels a road frequently will unnecessarily form a large image group by having all its captured instances stored by the system, even though OCR based plate read results alone could easily recognize it. Thus, precious system resources are wasted. A judicious utilization of system resources and a more efficient method of image grouping can be visualized where the system stores more images/features of vehicles that have difficult-to-read license plates to help identify such vehicles accurately, while storing less images/features and relying on OCR for easy-to-read license plates. In addition to the above difficulty, the manual image and text verification processes as disclosed by the above patent are cumbersome and error prone, requiring experienced reviewers along with a system to continuously monitor the performance of reviewers. Ideally, the manual feedback/verification process should be simple and more manageable. US patent application US20160092473A1 presents a method for parking management that captures and compares license plate features to identify vehicles at entry and exit points. However, the disclosed method ignores the most concise and unique feature of a vehicle, that is, the license plate number, while identifying vehicles. Moreover, it does not contain error handling in the case of image mismatches. Also, there is no provision of improving the performance of the system on the basis of past data. U.S. Pat. No. 8,265,988B2 describes a toll management and vehicle identification system where a first OCR stage is used to narrow down matching vehicle candidates. A second vehicle fingerprint identification stage operates on the candidates to determine the best matching pair. If a matching pair with reasonable confidence is not found a human operator is involved to manually identify a matching pair. Here it is worth noting that the number of candidates generated by the first stage can be large if the general quality of plates is poor. When this occurs, the complex fingerprint identification stage would become a bottleneck that would slow down traffic, causing congestion at toll exits. Moreover, the manual identification process described is cumbersome and does not apply to AVAC systems as fingerprint matching and pairing of vehicles is performed at toll exit points.

It is apparent that methods proposed in the prior art for LPR and feature recognition systems ignore computational efficiency and excessive memory usage aspects of the algorithms. These aspects are vital for successful deployment on low cost embedded platforms in a real-time scenario. Moreover, the role of human operator for error correction as described in the prior art is cumbersome and needs to be simplified. In particular, burdening the operator or the end user to visually compare vehicle matches or correct the reading errors of OCR should be avoided in AVAC applications. Another ignored aspect of LPR based systems pertains to the fact that 10% to 15% plate records inserted into LPR databases generally have reading errors. These errors are bound to adversely affect any future database query. An easy method of correcting misreads in plate records stored in an LPR database is required. Yet another important aspect that is not considered in the prior art is that conventional LPR systems tend to ignore vehicles whose plates were not readable, or vehicles where license plates were not found. This serious omission can prove costly as these very vehicles may be the ones that are wanted by law enforcement agencies. Thus, methods are needed to enable LPR systems to capture and categorize all vehicle records, as vehicles with read license plates, vehicles with unread license plates and vehicles without license plates, and store these categories in their databases for future reference. Moreover, LPR systems should not just record and store vehicle and plate images but also record short video clips of each passing vehicle as part of the plate record.

### SUMMARY

Signature matching of license plates and vehicles is achieved by comparing high dimensional feature vectors representing image patches around salient points (called corner points) in the images. Depending upon their types (floating point or binary) the feature vectors are compared by computing Euclidean or Hamming distance metrics. Euclidean distance in high dimensional space is hard to compute. Although fast approximate methods based on k-dimensional (k-d) trees have been proposed in the literature to reduce the complexity of computing Euclidean distance in high dimensional feature space, this operation still becomes a bottleneck when hundreds or thousands of license plate and vehicles images each represented by hundreds or thousands of high dimensional feature vectors are to be matched in real-time. On the other hand, binary feature vectors are compared using the Hamming distance metric, which for binary data can be computed by performing a bit-wise exclusive-OR (XOR) operation followed by a bit count on the result. This involves only bit manipulation operations which can be performed quickly, especially on modern computers where there is hardware support for counting the number of bits that are set in a word. Even though computing the distance between pairs of binary features can be done efficiently, using linear search for matching can be practical only for smaller data sets. For large data sets, linear matching becomes a bottleneck in most applications. Algorithms like k-d trees are not applicable for speeding up binary features comparison. Other algorithms such as those based on multiple hierarchical clustering trees are also not suitable for real-time applications including vehicle or license plate recognition, as the reference list of images is continuously being updated with the arrival of new vehicles. Hence, there is a need for methods that can speed-up the matching process of floating point or binary feature vectors in real-time signature matching applications. One objective of the present invention is to disclose simple and fast feature matching methods that are applicable to both floating point as well as binary feature vectors.

An embodiment of the present invention captures images and generates image corner points and their corresponding features, where an image may represent a license plate, a vehicle, or a part of a vehicle. The features may be expressed as floating point vectors, fixed point vectors or binary vectors that are sorted by their significance values (with the most significant feature at the top) and stored in a list. A preferred embodiment of the present invention utilizes prior art technique of Brown et al. Proc. CVPR-2005, pages 510-517, to compute the sorted list of features where significance values are expressed in terms of corner strengths and decreasing suppression radii. The disclosed method of the current invention selects C most significant corner points from the sorted list of each image, where C is the number of features that are deemed sufficient to reliably recognize an image from a group of reference images. The disclosed method stores C sorted features of each reference image in a database or any other data structure. Next, instead of performing a full linear search by matching C features of an image with C features of each reference image to find the best match, the disclosed method only matches the top F sorted features of an image with the top F sorted features of each reference image, and finds M closest (approximate) matching images. In a preferred embodiment, F is set much smaller than C, hence, finding M closest approximate matches requires order of magnitude less computations than the full linear search. Finally, the target image is compared with M best approximate matched reference images of the previous step by matching the entire list of C features of each image, to get an overall best match. It should be mentioned that the success of the above method lies in the fact that the image features used for comparison are sorted in an order of significance. Hence, the probability that the closest match found by the disclosed method is indeed the best match is extremely high. Moreover, even though the preferred embodiment of the invention uses the technique of Brown et al. 2005, to get an initial sorted list of features, any other feature sorting technique may be employed such as the technique described in U.S. Pat. No. 8,797,414B2.

In another embodiment of the present invention, further speedup in feature matching is achieved by extracting a summary of each feature, where the summary may constitute a sub-sampled version of a floating-point or binary feature. Thus, each feature vector is reordered into two parts: 1. a summary vector S; 2. the feature vector V (that is left behind after removing the summary). The two parts may be stored as separate entities or stored as a concatenation of the two. The combined feature vector F is formed by the union of S and V. The dimension of S is much smaller than that of V, and S may be considered a rough approximation of F. In an embodiment of the present invention, the process of computing the Euclidean distance for floating point feature vectors or Hamming distance for binary feature vectors, respectively, is as follows: First the summary vectors S are matched and the summary distance is computed. Next, if the summary distance found is higher than a predetermined threshold T the process is halted and the match is declared a bad match. On the other hand, if the summary distance is equal to or below the threshold T, the rest of the feature V is also matched and the combined distance of the feature F is computed by adding the two distances. By setting the threshold T to a suitable safe value, most of the bad matches are rejected at the summary matching stage, and only features that are close to each other are matched in detail. Thus computational complexity is reduced significantly.

Storage requirement of license plate and vehicle recognition systems based upon signature matching is typically high making implementation of prior art methods on embedded platforms highly challenging. Storing signatures of hundreds or thousands of images where each image is represented by a large number of high dimensional feature vectors requires excessive random access memory (RAM) and permanent storage space. A second objective of the present invention is to disclose methods that minimize storage requirement of license plate and vehicle recognition systems.

In a preferred embodiment of the present invention, storage requirements are minimized by replacing reference image features that have lost their utility, and avoiding storing multiple copies of reference images where ever possible. To keep storage requirements in check, the method discloses suitable conditions for adding new feature vectors of a license plate/vehicle to the reference feature data store, and replacing old feature vectors of a license plate/vehicle in the reference feature data store by the corresponding new feature vectors. In one embodiment of the present invention, new feature data corresponding to a license plate or a vehicle are added to the reference data when the image features show large differences when compared with the previously stored version(s) of the same image. In this way, different variants of feature data of a license plate or a vehicle are made available for future comparisons. The above method improves system accuracy when license plate or vehicle images are being captured under large variations in lighting conditions or when capture distances are varying. The method also helps when the cameras being used at different points have different characteristics. On the other hand, in another embodiment of the present invention, new feature data corresponding to a license plate or a vehicle replaces the previous feature data when the image features show small variations when compared with the previously stored version(s) of the same image. In this way any small changes that occur in the license plate or vehicle images over time are updated, and more representative and current features are available for improved future comparisons. It should be noted here that the difference between the current and previous feature data is computed through Euclidean or Hamming distance measures.

Another embodiment of the present invention associates the image feature addition and replacement policy with the OCR result accuracy or OCR result variation. The merit behind this strategy is that OCR accuracy/variation is a good indicator of image variability. If the difference in the images is small the OCR results remain stable and accurate, while if the difference in images is large the OCR results may vary and show inaccuracies. According to the disclosed method, if the OCR results for a certain license plate/vehicle are inaccurate or are varying, its new (current) image features are added to the reference features. On the other hand, if the OCR results for a certain license plate/vehicle are accurate or stable, new image features replace the old image features.

Prior art includes LPR systems that allow users to manually correct misread plate records that exist in their database, thereby improving the accuracy of subsequent database search queries. However, this manual correction is a time consuming and error prone exercise, where typically all capture instances of a misread plate are extracted by querying the database and manually corrected one by one. A third objective of the present invention is to simplify the process of locating and correcting misread errors in a large LPR database of plate records.

The invention discloses an LPR system where the plate records stored in the database consist of one or a plurality of textual data items including plate number, capture time, capture date, camera/system name, state/province, felony (in the case where the captured license plate matches with a number in a hot license plate list of a law enforcement agency), and any other comments. The plate record also includes plate and vehicle images, and possibly a short video clip of the vehicle. Each plate record further includes a plurality of image signatures/features of the license plate and/or vehicle. A database correction technique is disclosed in the present invention whereby one misread plate is extracted from the database and manually corrected, while the system automatically searches and corrects all other instances of the same plate within the database with the help of pattern/feature matching of plate and/or vehicle images. The system may correct all the instances of the plate/vehicle images found in the database or may search and present all the instances to a user for manual verification and correction. In another embodiment of the invention, a license plate gets captured and is corrected manually by a user on-the-fly before storing the number in the LPR database. The LPR system stores the plate record with the corrected number and automatically searches the database for other instances of the same plate with the help of pattern/feature matching and corrects all other instances of the license plates. In another embodiment of the invention the system makes use of partial plate number matching to limit the number of candidates that are to be considered for automatic number correction.

Prior art includes LPR and vehicle signature recognition algorithms operating as part of AVAC or parking management systems that (in the case of plate misreads) allow operators and registered users to override system decisions and open barriers/gates through external means including card readers, bio-metric scanners, key fob, cell-phones, wireless transceiver, electro-mechanical switches/buttons, or PC/Web based applications operating in wired or wireless modes. In the case of misreads, prior art methods burden an operator/user to visually verify image matches and manually correct the misread plate by entering the correct plate number using a keypad, keyboard or voice input. A fourth objective of the present invention is to simplify the interaction of a user/operator with the system.

According to the disclosed method, when an unmanned AVAC system fails to match the number plate of an authorized vehicle and wrongly bars its entry, the vehicle's driver/passenger issues an overriding command that opens the gate, allowing the vehicle to pass/enter. The overriding command may be issued through external means such as card reader, bio-metric scanner, key fob, cell-phone/smart phone application, transceiver, electro-mechanical switch/button, PC/Web based application, or any other interface using wired or wireless means. In one embodiment of the invention, the overriding command may contain means to open the gate/barrier. In another embodiment of the present invention, the overriding command may contain means to open the gate/barrier and may contain embedded information regarding the identity of the vehicle including its plate number. Thus, the user is not burdened to provide this information explicitly. The overriding action of opening the gate/barrier through the said external means is used as a signal to the AVAC system to identify a difficult-to-read license plate. Likewise, the overriding command containing embedded information regarding the vehicle's identity is used to further tune the LPR and vehicle signature recognition processes to correct their errors. As a result, the system figures out that a misread has occurred, identifies OCR errors and categorizes it as a difficult-to-identify vehicle/license plate. The system then takes corrective actions to improve the recognition of the said vehicle without the user having to visually match vehicles or enter the correct plate number via keypad, keyboard or voice input. Thus, the task of the user/operator is simplified and the LPR/vehicle recognition system learns from experience and performs better when it encounters the same vehicle again.

Prior art includes LPR systems that read license plates of vehicles and store the license plate images, vehicle images, and license plate data as plate records in their database. These plate records can then be searched by querying the database. However, the conventional LPR systems do not keep track of plates that they were unable to read or of vehicles where they could not find any license plates. A fifth objective of the present invention is to disclose an LPR system that accounts for all the passing traffic irrespective of whether a license plate was read or not, or whether a license plate was not found on a vehicle.

To handle applications that demand all the passing traffic to be accounted for, the present invention discloses an LPR system that categorizes and stores license plate records as read license plates, unread license plates and vehicles without license plates. Here, read license plates pertain to vehicles whose plates were read by the system, unread license plates pertain to vehicles where the system found a mounted license plate but was unable to read it, and vehicles without license plates pertain to vehicles where the system could not find a mounted license plate. Hence, the system enables a user to not only search the read license plates but also the unread plates and even vehicles with license plates missing. Moreover, as an additional aid to users, the LPR system may also include a short video clip of the vehicle as part of the plate record. The video clip may be recorded via a color or infrared camera.

In some situations, OCR based license plate recognition and maintaining license plate records in databases is discouraged due to privacy concerns. An embodiment of the present invention discloses a privacy mode selection method that allows an AVAC system, a parking management or a traffic management system to select between a normal operating mode and a privacy (respecting) mode. In the normal operating mode, both OCR and image feature recognition processes are used for license plate and/or vehicle recognition. While in the privacy mode of operation, the system does not display or store any license plate number in human readable form. In privacy mode the system may also be instructed not to perform OCR on license plate images and to solely rely on image feature recognition and machine readable features. In one embodiment of the invention, in privacy mode, the OCR comes into play only when a violation occurs or an un-authorized vehicle is detected. Thus, privacy of authorized vehicles or non-violators is respected as license plate numbers of these vehicles are never converted into human readable form.

To handle diverse security needs, an embodiment of the present invention discloses a security level selection method that allows an AVAC system, a parking management system or a traffic management system to switch among a plurality of security levels (or modes). At higher security levels, identification errors are prevented by more stringent checks and verifications. In one embodiment of the present invention, the system relies on OCR/license plate image based feature recognition at the normal security level, includes car image feature recognition at the next higher level, and biometric features/face recognition/car under-carriage recognition at the highest security levels.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE FIGURES

The accompanying Figures, which are incorporated herein and form part of the specification, illustrate the present invention and, together with the description, further serve to explain the principles of the invention and to enable a person skilled in the relevant art(s) to make and use the invention.

FIG. 1 is a simplified view of the hardware components of the license plate/vehicle recognition system based upon OCR and feature recognition processes, in accordance with one embodiment of the present disclosure.

FIG. 2 is a simplified block diagram depicting the computing hardware, according to one embodiment of the present disclosure.

FIG. 3 is a simplified schematic diagram depicting the major software components of the license plate/vehicle recognition system, in accordance with one embodiment of the present disclosure.

FIG. 4 is a simplified flow chart representing a fast method of determining the closest matching reference image for a given target image, according to one embodiment of the present disclosure.

FIG. 5 is a simplified flow chart representing a fast method of computing the Euclidean/Hamming distance between two multi-dimensional feature vectors, according to one embodiment of the present disclosure.

FIG. 6 is a depiction of a multi-dimensional feature vector and feature vector summary, according to one embodiment of the present disclosure.

FIG. 7 is a depiction of a reordered multi-dimensional feature vector and feature vector summary, according to one embodiment of the present disclosure.

FIG. 8 is a simplified flow chart depicting the process of addition of new image features and replacement of previous image features in a reference feature store, according to one embodiment of the present disclosure.

FIG. 9 A is a process flow block diagram of a method for correcting misread errors in an LPR database of plate records by utilizing image feature/signature recognition, according to one embodiment of the present disclosure.

FIG. 9 B is a process flow block diagram of another method for correcting misread errors in an LPR database of plate records by utilizing image feature/signature recognition, according to one embodiment of the present disclosure.

FIG. 10 A is a process flow block diagram of a method that simplifies the interaction of a user with an AVAC system for providing manual feedback in the case of vehicle identification error, where the user is not required to explicitly enter the license plate number, according to one embodiment of the present disclosure.

FIG. 10 B is a process flow block diagram of a method that simplifies the interaction of a user/operator with an AVAC system for providing manual feedback in the case of vehicle identification error, where the user/operator is not required to explicitly enter the license plate number, according to one embodiment of the present disclosure.

FIG. 11 A to E show few examples of external devices used by a user/operator for providing manual feedback to an AVAC system in the case of vehicle identification error, where a user/operator has to only press a button on a device, and where the user/operator is not required to explicitly enter the license plate number, according to one embodiment of the present disclosure.

FIG. 12 is a simplified block diagram of an LPR system that accounts for all the passing traffic by categorizing and storing license plate records as read license plates, unread license plates and vehicles without license plates, according to one embodiment of the present disclosure.

FIGS. 13 A and 13 B are representative images of the graphical user interface (GUI) of an automatic vehicle access control (AVAC) system, according to one embodiment of the present disclosure.

FIG. 14 is a simplified block diagram of a vehicle identification system that provides privacy mode selection, according to one embodiment of the present disclosure.

FIG. 15 is a simplified block diagram of a vehicle identification system that provides security level selection, according to one embodiment of the present disclosure.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The disclosure set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagrams in order to avoid obscuring the concepts of the present invention. One or more embodiments of the present invention will now be described.

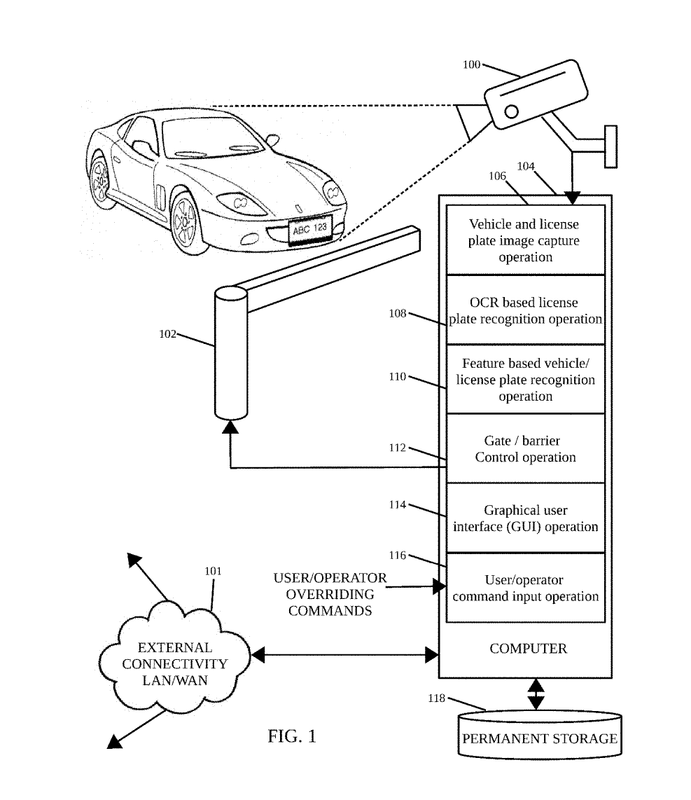

FIG. 1 is a simplified view of the hardware parts of the license plate/vehicle recognition system based upon OCR and feature recognition processes in accordance with one embodiment of the present disclosure. As shown in FIG. 1, an embodiment of the present invention employs one or a plurality of cameras 100 to capture image(s) of incoming, outgoing or passing vehicle(s) and/or their license plate(s). The camera(s) 100 may be analog or digital/Internet protocol (IP) video camera(s) interfaced with a computer 104 and delivering one or more streams of captured images to the computer. The camera(s) 100 may be standard definition (SD) cameras or high definition (HD) cameras operating in visible light wavelengths or infrared (IR) wavelengths. The computer 104 contains means to perform one or a plurality of operations including vehicle and license plate image capture operation 106, OCR based license plate recognition operation 108, feature based vehicle/license plate recognition operation 110, gate/barrier control operation 112, graphical user interface operation 114 and user/operator command input operation 116. The computer is further connected with one or a plurality of gate(s)/barrier(s) 102 and contains means to open or close a gate/barrier depending upon the decisions made by the operations (108 to 110), or when an overriding command is issued by a user/operator via user/operator command input operation 116. In addition, the computer may be connected to a permanent storage device 118 for storing vehicle recognition results. The permanent storage device may be a hard drive, USB drive, flash drive, memory card, USB controller based SATA drive, RAID device, internal flash memory, any network attached storage device or any other storage device. The computer 104 may also be connected to outside world via network interface to local area network (LAN) or wide area network (WAN) 101. It is worth mentioning that the computer 104 may consist of a single hardware unit performing the plurality of operations 106 to 116, or may comprise multiple connected hardware units with each unit dedicated to perform a sub-set of operations 106 to 116. In the case of multiple hardware units, the connection between the units may be via a bus architecture, a wired network or through wireless means. Moreover, the computer 104 may be a general purpose computer or personal computer (PC), a digital signal processor (DSP) board, a single board computer, a customized ASIC design, an FPGA board or any other computing hardware.

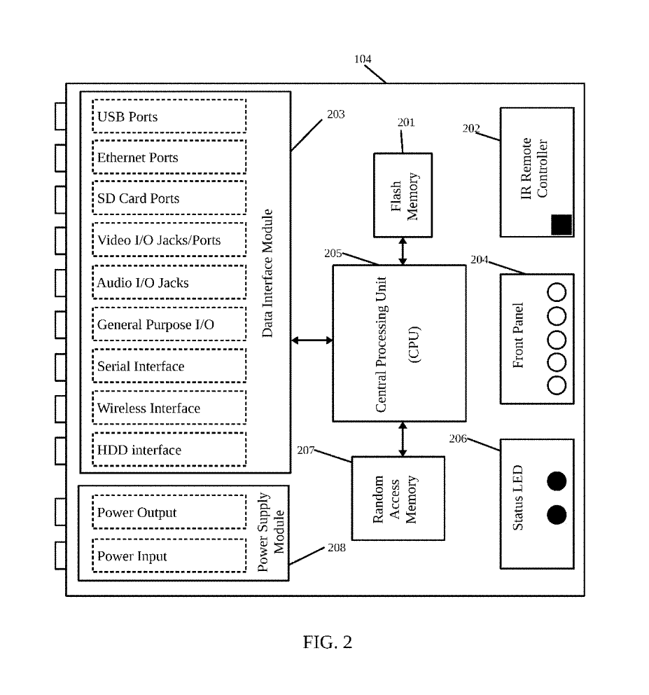

FIG. 2 is a simplified block diagram illustrating an exemplary computer hardware used in one embodiment of the present invention. The computer 104 consists of a processing hardware that includes a Central Processing Unit (CPU) 205, a Random Access Memory (RAM) 207, a Flash Memory 201, front panel buttons 204, IR remote controller circuitry 202, status LEDs 206, power supply module 208 and data interface module 203. The data interface module 203 supports one or a plurality of data interfaces including USB ports, Ethernet ports, SD Card ports, Video and audio I/O Jacks, General purpose I/O (GPIO) ports, Serial interface ports, Wireless interface and HDD connectors. The CPU may be a RISC processor, a digital signal processor (DSP), a Media Processor, a customized ASIC design, a VLIW processor, an FPGA, a system on chip (SOC), a system on module (SOM) or any other processing architecture. Data from the infrared and color cameras is fed to the CPU via appropriate interface ports. In one embodiment, the CPU extracts license plate and vehicle images from the camera signals, and processes these images using OCR and image feature detection techniques to read the license plate numbers, and to compute and compare vehicle and license plate signatures. The front panel buttons 204 are used to provide a simple user interface in a stand-alone operating mode. Alternatively, an IR remote controller module 202 may be used by a user to interact with the computing apparatus in a stand-alone operating mode. Other user interfaces 203 include Ethernet ports and wireless communication interface. The status LEDs 206 are used to signal the power ON/OFF state and the current status of the device including error conditions, connectivity and system states. A preferred embodiment of the present invention is designed to have low power consumption and small form factor to make it suitable for a variety of covert and overt applications. As an example, in one embodiment the computing apparatus 104 is fitted in a covert pole-mounted enclosure in a surveillance application. In another embodiment a car-mounted enclosure houses the processing apparatus for law enforcement applications. In yet another embodiment the processing apparatus is housed inside a camera enclosure. Electrical power can be supplied to the processing apparatus via a battery, power adapter or using Power-over-Ethernet (PoE) and the likes.

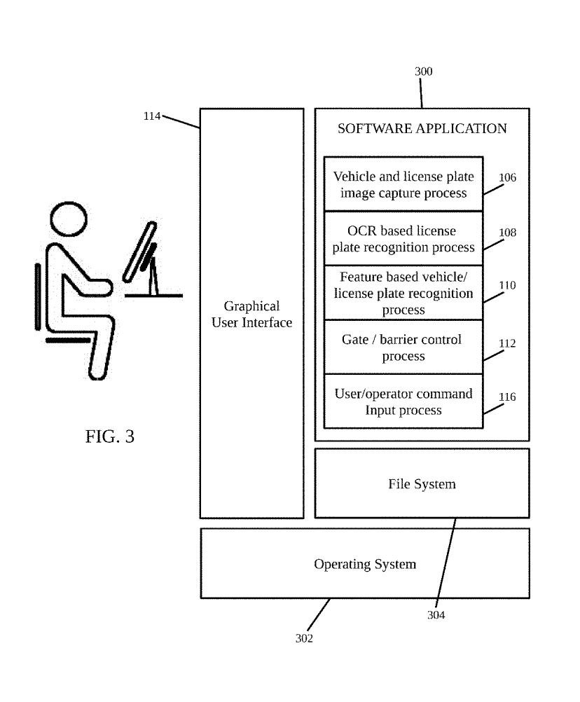

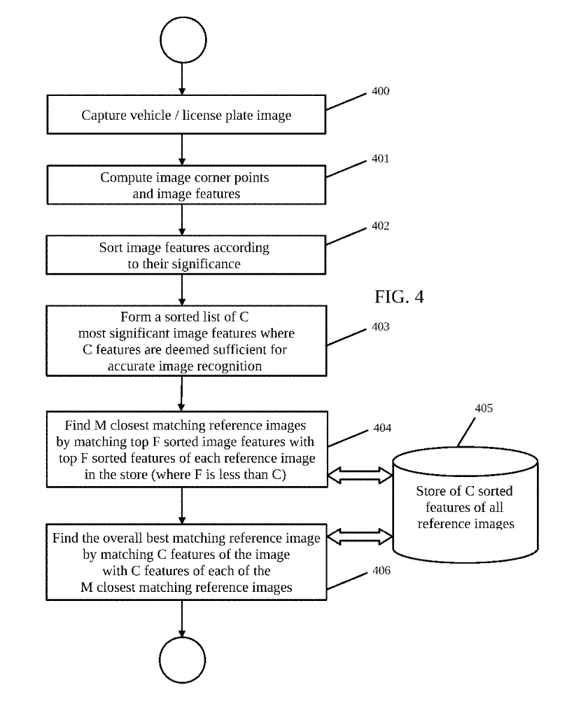

FIG. 3 is a simplified diagram representing the software running on the computer 104 of FIG. 1. The software consists of a software application 300 residing in the memory of the computer and executing under the control of an operating system 302. The software application connects to one or a plurality of storage devices through a file system 304. In addition, the application interacts with the user/operator via a graphical user interface (GUI) process 114 that may be available via a Web browser, a desktop PC software, a text terminal or a front panel/remote controller and TV/monitor combination. The software application 300 comprises one or a plurality of software processes including vehicle and license plate image capture process 106, OCR based license plate recognition process 108, feature based vehicle/license plate recognition process 110, gate/barrier control process 112 and user/operator command input process 116. The software processes (106 to 116) may be concurrent tasks/threads or functions executing on a single hardware unit or on multiple connected hardware units. In a preferred embodiment of the present invention the software application 300 further supports one or a plurality of functions including hot license plate list management, storing data in a database, handling user interfaces, video recording, database management, database searching, rendering OCR and vehicle recognition results on display monitors, managing the graphical user interfaces, firmware upgrading, event tagging, system settings, managing GPIO signals, handling GPS data, sending Email/SMS messages and communicating with external applications.

Furthermore, different embodiments of the software application 300 may contain features like dynamic video source detection, whereby the selection of the appropriate camera input source is made automatically on the basis of the availability of the video signal; and dynamic video standard detection, whereby the selection of NTSC/PAL/SECAM or HD video standards is made automatically. Different embodiments of the software application 300 may also provide support for FAT32, FAT16, HFS, HFS+, Ext2, Ext3, NTFS, or any other standard or proprietary file system for storing license plate records, images and video files. Moreover, an embodiment of the present invention may contain a TCP/IP stack or any other suitable communication stack to allow for connection to one or more networked devices. In addition to this, a preferred embodiment of the present invention uses at least one of a plurality of database formats including SQLite, SQL, MySQL or any other database format to store license plate records, images and videos.

FIG. 4 is a simplified flow chart representing a fast method of determining the closest matching reference image for a given target image, according to one embodiment of the present disclosure. An embodiment of the present invention captures images of vehicles and their license plates 400 using appropriate cameras. The system generates image corner points and their corresponding features 401, where an image may represent a license plate, a vehicle, or a part of a vehicle. The features may be expressed as floating point vectors, fixed point vectors or binary vectors. The features are sorted by their significance values (with the most significant feature at the top) 402 and stored in a list. A preferred embodiment of the present invention expresses significance values in terms of corner strengths and decreasing suppression radii. The disclosed method of the current invention selects C most significant corner points 403 from the sorted list of each image, where C is the number of features that are deemed sufficient to reliably recognize an image from a group of reference images. The disclosed method stores C sorted features of each reference image in a reference feature store 405, where the reference feature store may be a database or any other data structure. Next, instead of performing a full linear search by matching C features of an image with C features of each reference image to find the best match, the disclosed method only matches the top F sorted features of an image with the top F sorted features of each reference image, and finds M closest (approximate) matching images 404. In a preferred embodiment F is set much smaller than C, hence, finding M closest approximate matches requires order of magnitude less computations than the full linear search. In one embodiment C is set to 500, F is set to 100 and M is set to 5. These settings result in almost 25 times reduction in computations needed to find the 5 best approximate matches in place of one best match. Finally, the target image is compared with M best approximate matched reference images of step 404 by matching the entire list of C features of each image, to get an overall accurate match 406. It should be mentioned that the success of the above method lies in the fact that the image features used for comparison are sorted in an order of significance. Hence, the probability that the closest match found by the disclosed method is indeed the best match is extremely high. It should also be noted that if the number of reference images is large, the overhead of the final comparison step of matching M images accurately is minimal compared to the large reduction in computational complexity of the approximate matching step. It is worth pointing out that the above method is generic enough to handle floating point, fixed point or binary feature vectors.

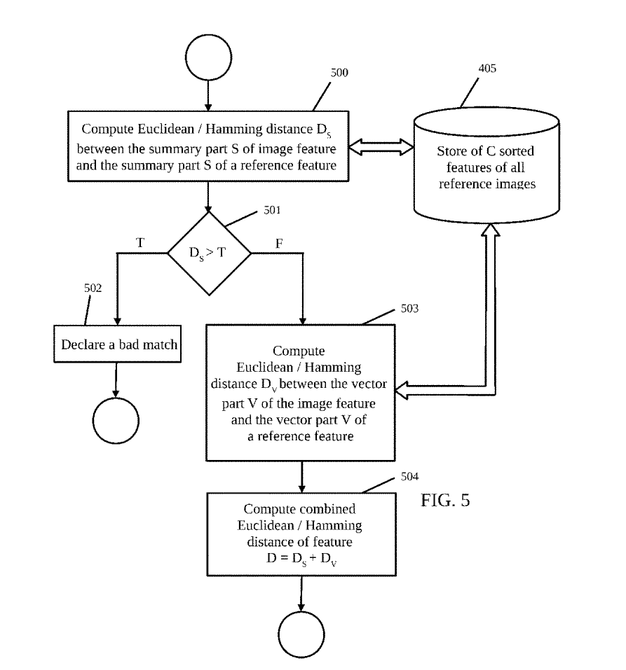

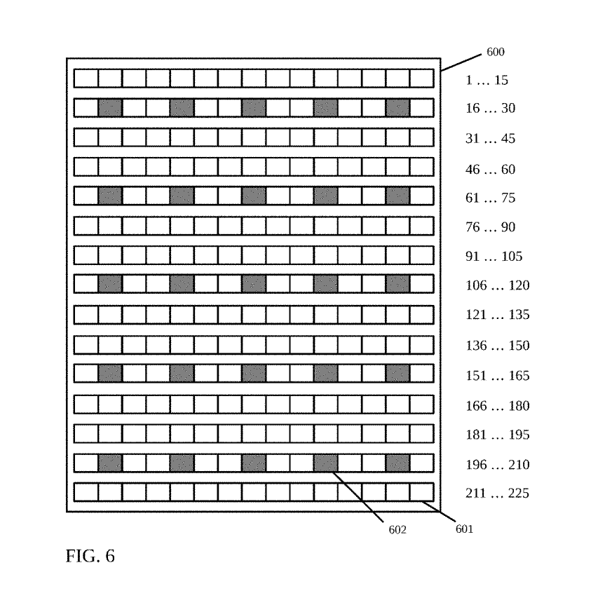

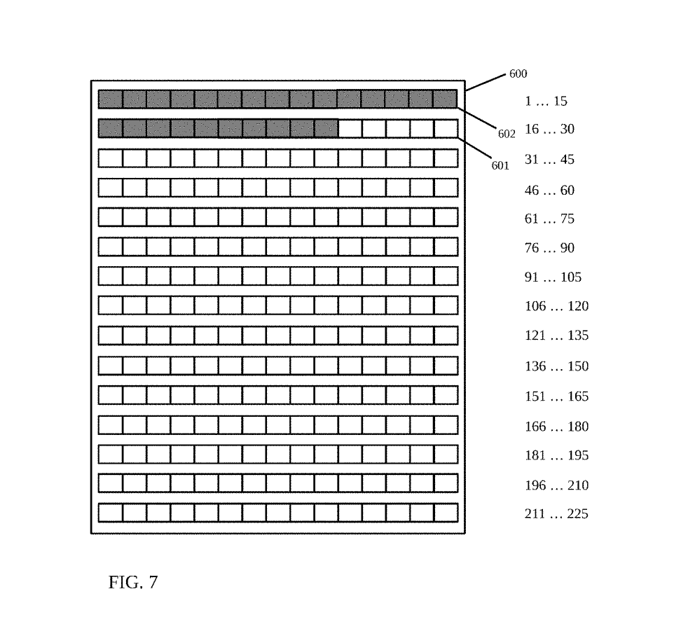

FIG. 5 is a simplified flow chart representing a fast method of computing the Euclidean/Hamming distance between two multi-dimensional feature vectors according to one embodiment of the present disclosure. In a preferred embodiment of the present invention, summary of each feature vector is extracted, where the summary may constitute a sub-sampled version of a floating-point or binary feature vector. Thus, each feature vector is reordered into two parts: 1. a summary vector S; 2. the feature vector V (that is left behind after removing the summary). FIG. 6 shows an exemplary two hundred and twenty-five dimensional feature vector 600. Depending upon the type of feature vector, each dimension is represented by a floating point number, a fixed point number, a byte or a bit. Sub-sampled components of the feature vector shown in gray color 602 form the summary part S, while the rest of the vector components shown in white 601 form the vector V. The two parts may be stored as separate entities or the vector may be reordered and stored as a concatenation of the two parts as shown in FIG. 7, where the combined feature vector F is formed by the union of S and V. As shown in FIG. 6 and FIG. 7 the dimension of S is much smaller than that of V, and S may be considered a rough approximation of F. In a preferred embodiment of the present invention, the dimension of S is set to twenty-five, while that of F is set to two hundred and twenty-five. The fast method of computing the Euclidean/Hamming distance between two multi-dimensional feature vectors as shown in FIG. 5, starts with computing the Euclidean/Hamming distance D_{S} between the summary part S of an image feature and the summary part S of a reference feature 500. It is worth mentioning that reference features of reference images are stored in a reference store 405, where the reference store may be a database or any other data structure, and where features of each reference image are stored as a sorted list. Next, if the computed summary distance D_{S} is found to be higher than a predetermined threshold T the process is halted and the match is declared a bad match 502. On the other hand, if the summary distance D_{S} is found equal to or below the threshold T, the rest of the feature part V is matched with the reference feature part V 503 and the combined distance of the feature F is computed by adding the two distances 504. By setting the threshold T to a suitable safe value, most of the bad matches are rejected at the summary matching stage, and only features that are close to each other are matched in detail. Thus computational complexity is reduced significantly.

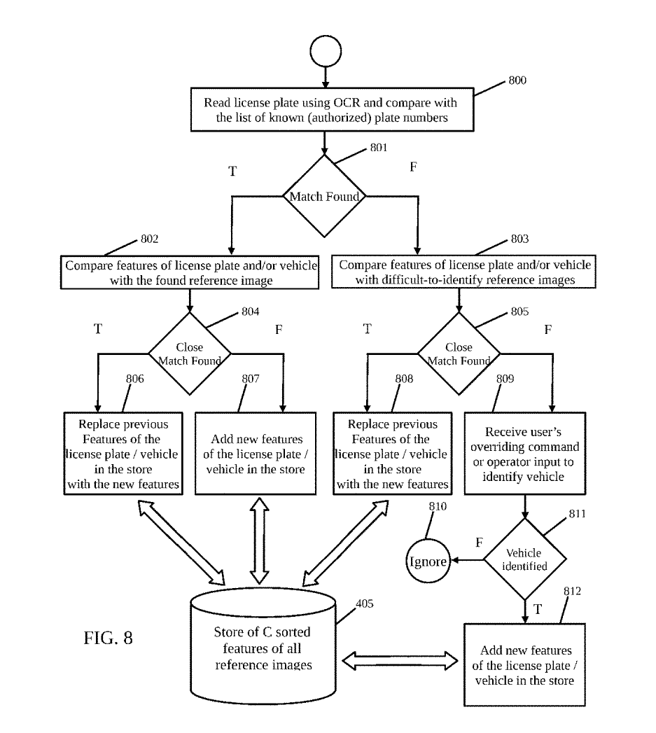

FIG. 8 is a simplified flow chart according to a preferred embodiment of the present invention, whereby storage requirements of an AVAC system are minimized by replacing reference image features that have lost their utility, and avoiding storing multiple copies of reference images where ever possible. The disclosed method determines suitable conditions for adding new feature vectors of a license plate/vehicle to the reference feature data store, and replacing old feature vectors of a license plate/vehicle in the reference feature data store by the corresponding new feature vectors.

In one embodiment of the present invention, the system reads a vehicle's license plate using OCR and matches the read number with its list of known (authorized) numbers 800. Two cases can arise as a result of this matching 801:

Case 1: the read license plate number matches with a reference license plate number. In this case the system matches and compares features of the read license plate/vehicle with those of the matched license plate number/vehicle 802. If a close match is found 804, the system replaces the old features of the license plate/vehicle in the reference feature store 405 with the new features 806. On the other hand, if a close match is not found 804, the new features are added in the reference feature store 405 for the said vehicle number. Thus a plurality of feature sets exist in the reference feature store for the read license plate number.

Case 2: the read license plate number does not match with a reference license plate number. For unread (difficult) plate cases the system maintains a difficult-to-identify reference image list. The system matches and compares features of the unmatched license plate/vehicle with those in the difficult-to-identify reference image list 803. If a close match is found 805 the system replaces the old features of the license plate/vehicle in the reference feature store 405 with the new features. On the other hand, if a close match is not found 805, the system receives user's overriding command or operator input to identify the vehicle 809. If the vehicle is identified as authorized 811 the new features are added in the reference feature store 405 for the said vehicle 812. On the other hand, if the vehicle is not identified as authorized 811, it is ignored 810.

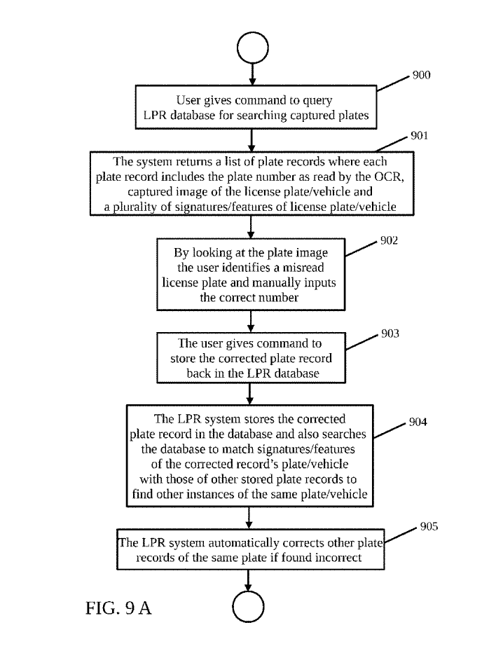

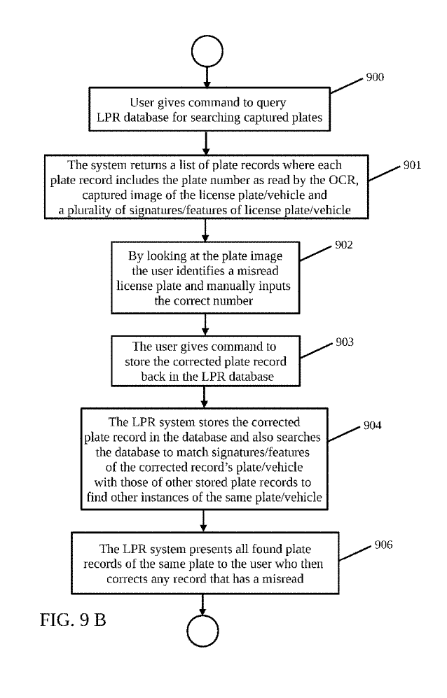

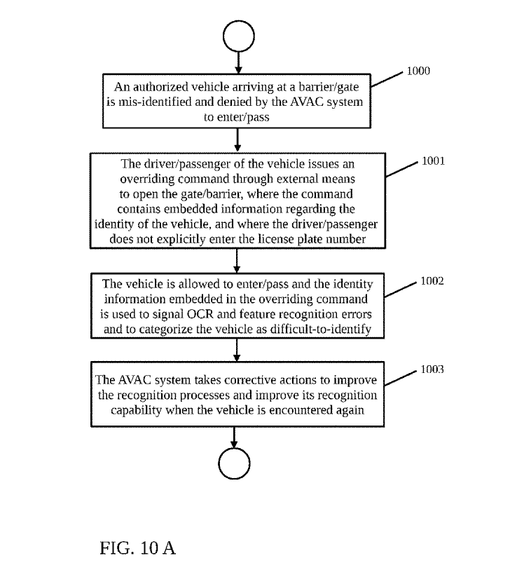

FIG. 9 A is a process flow block diagram of a method for simplifying the process of correcting misread errors in an LPR database of license plate records by utilizing image feature/signature recognition according to one embodiment of the present disclosure. The invention discloses an LPR system where the license plate records stored in the database consist of one or a plurality of textual data items including license plate number, capture time, capture date, camera/system name, state/province, felony (in the case where the captured license plate matches with a number in a hot license plate list of a law enforcement agency), and any other comments. The license plate record also includes plate and vehicle images, and may also include a short video clip of the vehicle. The license plate record may further include a plurality of image signatures/features of the license plate and/or vehicle that can be used to match stored license plate records with a target license plate image. Furthermore, the LPR system provides means to enable a user to search license plate records in the database and to manually correct any misreads. The disclosed database correction technique starts with the user giving a command to query LPR database for searching one or more license plate records 900. In one embodiment, the database query command may be issued to search all license plate records captured within a time-frame or on a certain date 900. In response, the system returns a list of license plate records and presents the user with the license plate numbers as read by the OCR as well as the captured images of license plates/vehicles 901. By visually comparing the OCR results with the respective license plate images the user identifies misread license plates, and inputs the correct license plate number(s) 902. The user then gives the command to store the corrected license plate number(s) back in the LPR database 903. In response, the LPR system stores the corrected license plate record(s) in the database and also searches the database to match signatures/features of each corrected record's license plate/vehicle with those of other stored license plate records to find other instances of the same license plate/vehicle 904. The LPR system automatically corrects all license plate records of the same license plate if found incorrect 905. FIG. 9 B is a process flow block diagram of another method for simplifying the process of correcting misread errors in an LPR database of license plate records by utilizing image feature/signature recognition, according to one embodiment of the present disclosure. The method is similar to that of FIG. 9A except for the fact that instead of automatically correcting other license plate records of the same license plate if found incorrect 905, the LPR system presents all found license plate records of the same license plate to the user who then verifies and manually corrects any record that has a misread 906. It may be noted here that an embodiment of the present disclosure, instead of storing the image features/signatures in a database, may generate the features/signatures on-the-fly. Likewise, license plate records can be corrected as they are captured without storing/querying the database. In addition, the corrected license plate records may be used by the system to adaptively improve its performance by categorizing difficult-to-read license plates and using signature/feature matching on such license plates to reduce future OCR errors. All such modifications fall within the scope of the present disclosure.

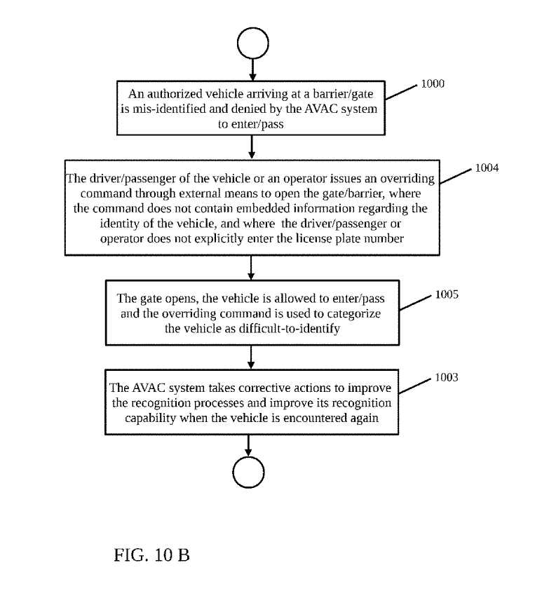

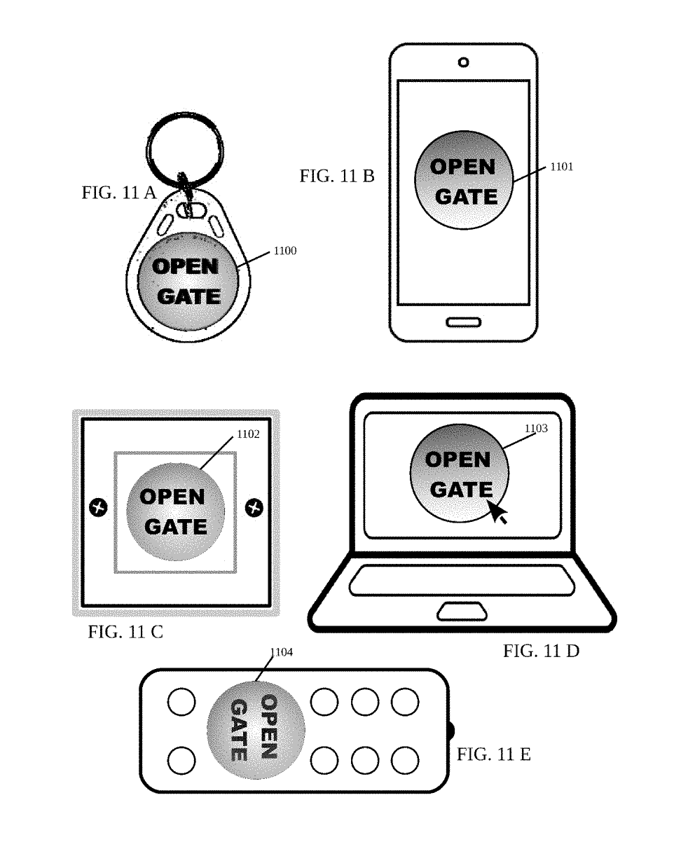

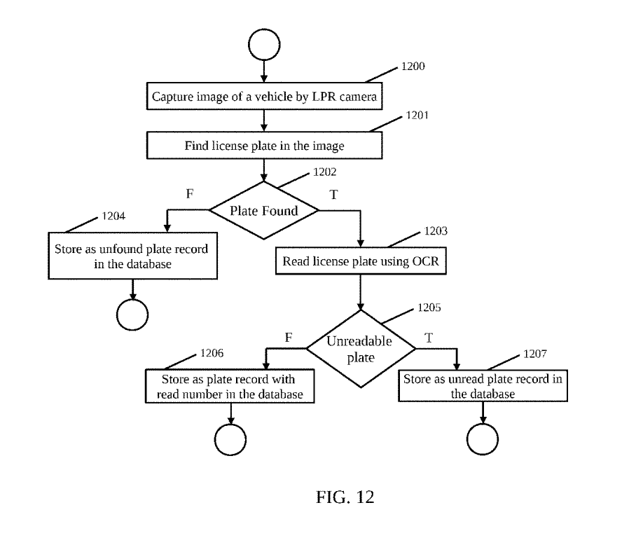

FIG. 10 A is a process flow block diagram of a method that simplifies the interaction of a user with an AVAC system for providing manual feedback in the case of vehicle identification error. According to the disclosed method, when an authorized vehicle arriving at a barrier/gate is misidentified and denied by the AVAC system to enter/pass 1000, the driver/passenger of the vehicle issues an overriding command through external means to open the gate/barrier. Here, the overriding command contains embedded information regarding the identity of the vehicle, and the driver/passenger does not explicitly input the license plate number 1001. Exemplary external means used to send the overriding command as shown in FIGS. 11 A to 11 E include key fob, cell phone/smart phone application, electro-mechanical switch, personal computer application and IR remote controller. As shown in FIGS. 11 A to 11 E, the user sends an overriding command with the single press of a button (1100, 1101, 1102, 1103, 1104), and without having to enter the correct license plate number. Other means such as card reader, bio-metric scanner, transceiver, or any other communication device may also be used and the invention is not limited by the type of external device used. As a result of the overriding command, the vehicle is allowed to enter/pass and the identity information embedded in the overriding command is used to signal OCR and feature recognition errors and to categorize the vehicle as difficult-to-identify 1002. Making use of this information the AVAC system takes corrective actions to improve the recognition processes and improve its recognition capability when the vehicle is encountered again in the future 1003. Thus, the task of the user/operator is simplified and the LPR/vehicle recognition system learns from experience and performs better when it encounters the same vehicle again.

FIG. 10 B is a process flow block diagram of another method that simplifies the interaction of a user with an AVAC system for providing manual feedback in the case of vehicle identification error. According to the disclosed method, when an authorized vehicle arriving at a barrier/gate is misidentified and denied by the AVAC system to enter/pass 1000, the driver/passenger of the vehicle or an operator issues an overriding command through external means to open the gate/barrier. Here, the command does not contain embedded information regarding the identity of the vehicle, and the driver/passenger or the operator does not explicitly input the license plate number 1004. Exemplary external means used to send the overriding command as shown in FIGS. 11 A to 11 E include key fob, cell phone/smart phone application, electro-mechanical switch, personal computer application and IR remote controller. As shown in FIGS. 11 A to 11 E, the user sends an overriding command with the single press of a button (1100, 1101, 1102, 1103, 1104), and without having to enter the correct license plate number. Other means such as card reader, bio-metric scanner, transceiver, or any other communication device may also be used and the invention is not limited by the type of external device used. As a result of the overriding command, the gate opens, the vehicle is allowed to enter/pass and the overriding command is used to categorize the vehicle as difficult-to-identify 1005. Making use of this information the AVAC system takes corrective actions to improve the recognition processes and improve its recognition capability when the vehicle is encountered again in the future 1003. Thus, the task of the user/operator is simplified and the LPR/vehicle recognition system learns from experience and performs better when it encounters the same vehicle again.

FIG. 12 discloses an LPR system that accounts for all the passing traffic irrespective of whether a license plate was read or not, or whether a license plate was not found on a vehicle. The LPR system of FIG. 12 categorizes and stores license plate records as read license plates, unread license plates and vehicles without license plates. Here, read license plates pertain to vehicles whose plates were read by the system (even with errors), unread license plates pertain to vehicles where the system found a mounted license plate but was unable to read it (due to plate damage or age effects), and vehicles without license plates pertain to vehicles where the system could not find a mounted license plate.

When a vehicle arrives in the field of view of the LPR camera the LPR system captures at least one image of the vehicle 1200. The system then tries to find a license plate in the vehicle image 1201. If a license plate is not found 1202, the system stores the record in the not-found plate category in its database 1204. On the other hand, if a license plate is found 1202, the system employs an OCR to read the plate number 1203. The license plate may be damaged or dirty and the OCR algorithm may not be able to read it 1205. In this case the system stores the record in the unread plate category 1207. On the other hand, if the OCR algorithm is successful in reading the plate (even with errors) the system stores the record in the read plate category 1206. Hence, by storing the above plate record categories in the database, the system enables a user to not only search the read license plates but also the unread plates and even vehicles without license plates. Moreover, as an additional aid to the users, the LPR system may also include a short video clip of the vehicle as part of the plate record. The video clip may be recorded via a color or infrared camera.

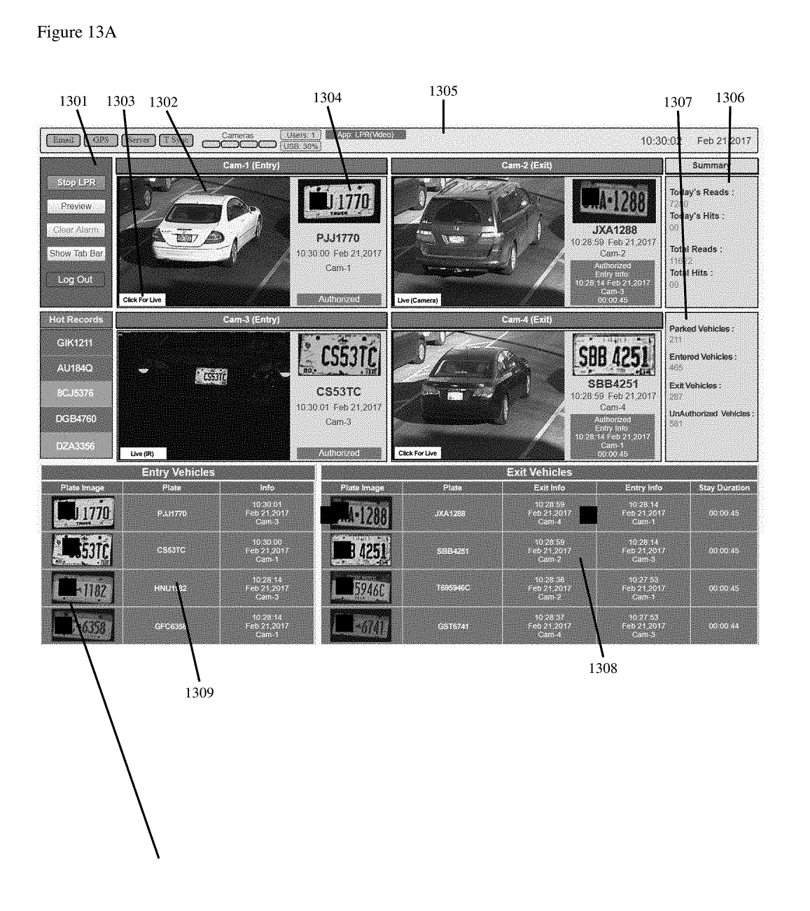

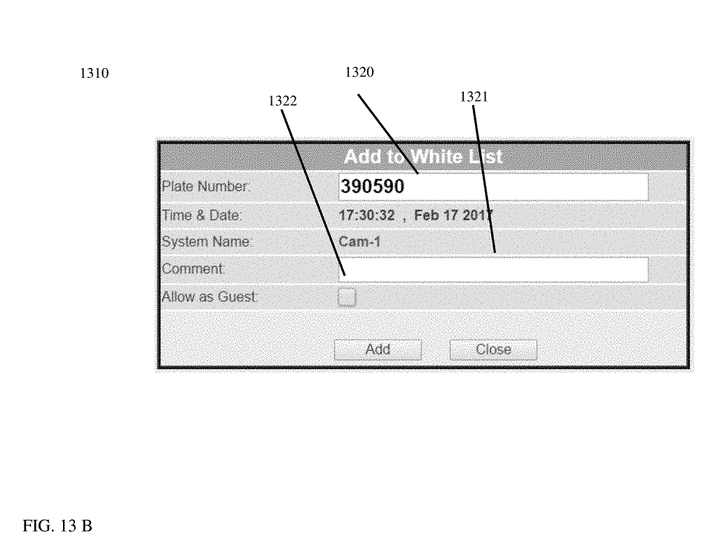

FIG. 13 A is a typical image of the graphical user interface (GUI) of an automatic vehicle access control (AVAC) system, according to one embodiment of the present disclosure. The system provides a control panel 1301, window panes 1302 to watch color live view, infrared live view or captured images of vehicles selectable via button 1303, window pane 1304 to view current captured license plate image and its details, system status bar 1305, plate capture summary display window 1306, vehicle entry-exit and parking summary 1307, exited vehicles details section 1308, entered vehicles details section 1309 and hot (wanted) number alerts list 1310. The system of FIG. 13 A provides the user with one or a plurality of search options to query its database. The search options may include captured plate number search, wild-card pattern search, captured hot number search, authorized plates search, unauthorized plates search, guest plates search, unread plates search, vehicles without plates search, manually corrected plate numbers search, map location based search, stay duration based search, capture camera name based search and gates/barriers based search. As seen in FIG. 13 A, the system can handle a plurality of entry and exit barriers, and a plurality of white lists and hot lists. FIG. 13 B is a typical input form of the AVAC GUI, according to one embodiment of the present disclosure. A user enters a license plate number in the white (allowed vehicle) list via the field 1320, and may enter a searchable comment via the field 1321. A user may also indicate to the system via check box 1322 whether the entered number is of a permanent member or a guest.

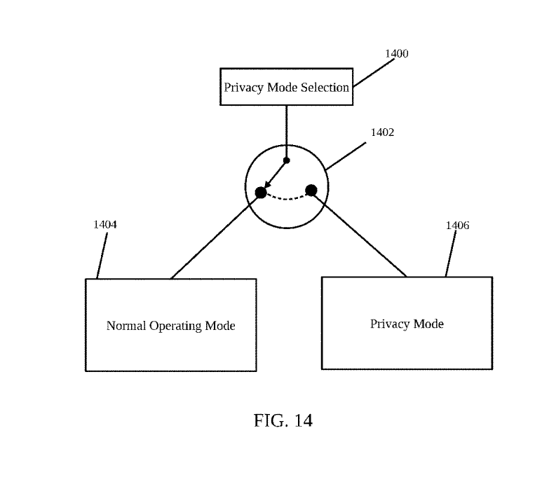

To alleviate privacy concerns, an embodiment of the present invention discloses a privacy mode selection method that allows an AVAC system, a parking management or a traffic management system to select between a normal operating mode and a privacy mode. A simplified exemplary privacy mode selection process is shown in FIG. 14. The selection can be made via a switch 1402 that may be part of the graphical user interface or may be activated via a configuration variable or file. In the normal operating mode 1404, both OCR and image feature recognition processes are used for license plate and/or vehicle recognition, and captured or searched license plate numbers are displayed in the GUI. On the other hand, in the privacy mode of operation 1406, the system does not display any license plate number computed by the OCR in the GUI, or store any license plate number in its database in human readable form. In another embodiment, the system is configured not to perform OCR on license plate images and to solely rely on image feature recognition and machine readable features, while operating in the privacy mode. In yet another embodiment, when operating in the privacy mode the OCR is performed only when a violation occurs or when an un-authorized vehicle is detected.

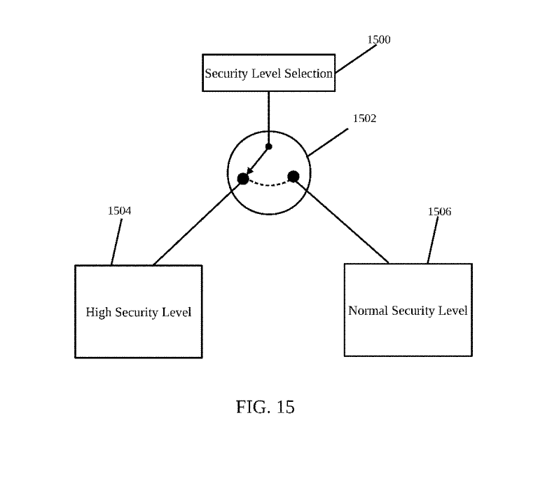

To handle diverse security needs, an embodiment of the present invention discloses a security level selection method that allows an AVAC system, a parking management system or a traffic management system to switch among a plurality of security levels (or modes). A simplified exemplary security level selection process is shown in FIG. 15. The selection can be made via a switch 1502 that may be part of the graphical user interface or may be activated via a configuration variable or file. In one embodiment of the present invention, when operating in the normal security level 1506, the system relies on OCR/license plate image based feature recognition, while when operating at the high security level 1504, the system includes car image features in the recognition process. In another embodiment, the system includes biometric features, face recognition and car under-carriage recognition at the higher security levels.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit of scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more”. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 1 12, sixth paragraph, unless the element is expressly recited using the phrase “means for” or, in the case of a method claim, the element is recited using the phrase “step for”.

1. A method for improving the accuracy of license plate recognition (LPR) applications of various kinds and forms, the method comprising:
using an optical character recognition (OCR) process to automatically read vehicle license plate numbers,
verifying/correcting the OCR results through an image feature recognition process that generates features/signatures of one or a plurality of license plate and/or vehicle images and matches them with stored features/signatures of reference images, and where the image feature recognition process further comprises:
sorting of generated features of each image by their significance values, storing a predetermined number of sorted features of each image in a sorted list, where the number of features stored in each image's sorted list is sufficient to accurately identify the image,
selecting a subset of most significant sorted features for each image from its corresponding list of sorted features,
matching the license plate and/or vehicle images with the reference images using the selected subset of most significant sorted features of each image to obtain a plurality of closest matching reference images, and
matching the license plate and/or vehicle images with the closest matching reference images obtained in the previous step, using the entire number of features stored in the sorted list of each image to obtain the overall best image match.

2. The method of claim 1, where the same number of sorted features are stored for every image, or different number of sorted features are stored for different images.

3. The method of claim 1 where a license plate/vehicle image is represented by one or a plurality of lists of sorted features, where the features are represented by multi-dimensional floating point vectors, fixed point vectors or binary vectors.

4. A method for reducing the computational complexity of computing the Euclidean or Hamming distance between a first multi-dimensional feature vector and a second multi-dimensional feature vector, in an image feature recognition application, the method comprising:
dividing each feature vector into two sub-vectors, a summary sub-vector and a left-over sub-vector that excludes components of the summary sub-vector, where the combined feature vector is formed by the union of the two sub-vectors,
computing the Euclidean or Hamming distance between the summary sub-vectors of the two features and comparing the computed summary distance with a threshold value to identify a good or bad summary sub-vector match,
in the case of a good summary sub-vector match, computing the Euclidean or Hamming distance between the left-over sub-vectors of the two features to determine left-over distance, and adding the summary distance with the left-over distance to compute the total distance.
In the case of a bad summary sub-vector match, discontinuing further matching of the two features and declaring the feature match as bad.

5. The method of claim 4, where the feature vectors may be multi-dimensional floating point vectors, fixed point vectors or binary vectors.

6. A method for reducing the data storage requirements of license plate recognition (LPR) and image feature recognition applications of various kinds and forms, the method comprising:
using an optical character recognition (OCR) process to automatically read the license plate number of the current vehicle,
verifying/correcting the OCR results through an image feature recognition process that generates features/signatures of the current vehicle and/or its license plate and matches them with stored features/signatures of the reference images, and where the image feature recognition process further comprises:
inserting feature data of the current vehicle and/or its license plate in the reference data-store when the OCR fails to match the current license plate number with any license plate number in the reference data store,
replacing previous feature data of a license plate/vehicle image in the reference data store by its current feature data when the OCR is successful in matching the current license plate number with a previous license plate number in the reference data store.

7. A method for correcting OCR misread errors in license plate records stored in the database of a license plate recognition (LPR) system, where a plate record contains one or a plurality of items including the license plate number, license plate and/or vehicle image(s), image signatures/features of the license plate and/or vehicle, the method comprising:
querying of the LPR database by a user to extract stored license plate records,
manual correction of one or a plurality of misread license plate numbers by the user through visual inspection,
the user indicating to the LPR system through a command that manual correction(s) have been made,
in response to the above command, searching of the database by the LPR system to find other instances of the manually corrected plate records using image signature/feature matching techniques,
as a result of the above search, the LPR system automatically correcting other instance(s) of the manually corrected plate record(s) if misread by the OCR, or the LPR system presenting the user with other instance(s) of the manually corrected plate record(s) if misread by the OCR for verification and manual correction.

8. The method of claim 7, where the image signatures/features of the license plate and/or vehicle are not stored in the LPR database as part of the license plate records but are generated on-the-fly using the images of the license plate and/or vehicle.

9. The method of claim 7, where the LPR system makes use of approximate plate number matching to limit the number of candidates that are to be considered for automatic plate record correction.

10. A method to simplify human interaction with an automatic vehicle access control (AVAC) system when the system misreads license plate numbers and denies an authorized vehicle to enter/pass, the method comprising issuing of an overriding command by a user to open the gate/barrier through a single press of a button on an external device, where the overriding command contains embedded information regarding the identity of the vehicle, including its license plate number, and where the user is not burdened to provide this information explicitly.

11. The method of claim 10, where the embedded information in the overriding command is used by the AVAC system to perform one or a plurality of tasks including, identifying a difficult-to-read license plate, correcting OCR errors and improving license plate/vehicle recognition capability.

12. The method of claim 10, where the overriding command is issued through one or more external devices including card reader, bio-metric scanner, key fob, cell-phone/smart phone, wireless transceiver, electro-mechanical switch/button, and PC/Web based application, operating in wired or wireless mode.

13. A method to simplify human interaction with an automatic vehicle access control (AVAC) system when the system misreads license plate numbers and denies an authorized vehicle to enter/pass, the method comprising issuing of an overriding command by a user to open the gate/barrier through a single press of a button on an external device, where the overriding command is used by the AVAC system to place the license plate in a difficult-to-read category.

14. The method of claim 13, where the overriding command is used by the AVAC system to improve its recognition capability, and where the overriding command is issued through one or more external devices including card reader, bio-metric scanner, key fob, cell-phone/smart phone, wireless transceiver, electro-mechanical switch/buttons, and PC/Web based application, operating in wired or wireless mode.

15. An automatic license plate recognition (LPR) system that places captured plate records into one or a plurality of categories including read license plates that pertain to vehicles whose plates were read by the system, unread license plates that pertain to vehicles where the system found a license plate mounted on a vehicle but was unable to read it, and vehicles without license plates that pertain to vehicles where the system could not find a mounted license plate, and where the LPR system stores the above plate record categories in its database, and provides the user with the ability to search its database for each category.

16. The system of claim 15, where a license plate record includes one or a plurality of video clip(s) of a vehicle associated with the license plate and recorded by a color or infrared camera, where the system stores the video clip(s) in a database, and where the video clip(s) can be searched in the database by a user, and downloaded and/or played back.

17. A license plate and/or vehicle recognition system having the means of selecting a plurality of operating modes including a normal operating mode and a privacy mode, where the normal operating mode utilizes both the OCR and image feature/signature recognition processes for license plate and/or vehicle recognition and displays captured license plate numbers on the system's graphical user interface, and where the privacy mode neither displays any license plate number computed by the OCR on the system's graphical user interface, nor stores any license plate number in the system's database in human readable form.

18. The method of claim 17, where the selection between the normal operating mode and the privacy mode is made via a switch that is part of the system's graphical user interface, or via a configuration variable or file.

19. The method of claim 17, where the system is configured not to perform OCR on license plate images and to solely rely on image feature recognition and machine readable features, when operating in the privacy mode.

20. The method of claim 17, where in the privacy mode, OCR is performed on a license plate image only when a traffic violation occurs or when an un-authorized vehicle is detected.
